(19) United States
(12) Patent Application Publication
(10) Pub. No.: US 2022/0242151 A1
(43) Pub. Date: Aug. 4, 2022

(54) ADJUSTING MECHANISM AND PRINTING APPARATUS

(71) Applicant: CASIO COMPUTER CO., LTD., Tokyo (JP)

(72) Inventor: Masahiro HORI, Tokyo (JP)

(21) Appl. No.: 17/590,542

(22) Filed: Feb. 1, 2022

(30) Foreign Application Priority Data
Feb. 4, 2021 (JP) 2021-016202

(51) Int. Cl. B41J 25/00; B41J 19/20; B41J 29/38

(52) U.S. Cl. CPC B41J 25/001; B41J 29/38; B41J 19/205

(57) ABSTRACT

An adjusting mechanism includes an adjusting plate and a screw type adjuster. The adjusting plate is provided in at least one end of an interlocking shaft that interlocks a pair of driving belts provided in a second direction and is attached to an end of the interlocking shaft. The screw type adjuster is configured to be capable of adjusting a position of a moving body engaged to the pair of driving belts by being rotated to move the adjusting plate along a first direction different from the second direction.

### CROSS-REFERENCE TO RELATED APPLICATION

This application is based upon and claims the benefit of priority under 35 USC 119 of Japanese Patent Application No. 2021-016202, filed on Feb. 4, 2021, the entire disclosure of which, including the description, claims, drawings, and abstract, is incorporated herein by reference in its entirety.

### BACKGROUND

### 1. Field of the Invention

The present invention relates to an adjusting mechanism and printing apparatus.

### 2. Description of the Related Art

In a configuration in which a moving body such as a carriage including a print head in a printing apparatus moves while being guided on both sides by a pair of axes, if the carriage is assembled in a state tilted with relation to a printing target, misalignment of a printing position occurs when printing is performed.

When the misalignment in the printing position occurs, for example, if an attempt is made to perform precise printing such as multi-pass printing or singling, the print result is misaligned in each pass, and a high definition finish cannot be achieved.

Conventionally, the following technique is known. The movement of the carriage is controlled with a predetermined origin position as a reference. As a method to detect the origin position, the following methods are performed. For example, the increase of the current value of the driving motor that occurs when the stopper of the carriage hits a predetermined striking portion is detected. Moreover, in addition to the above change of the current value of the driving motor, the driving of the motor that operates the print head being driven by predetermined input power is detected (for example, JP 2011-110841).

Normally, when the assembling is performed, the moving body such as the carriage is assembled matched with a reference position such as the origin position as described above. However, in the actual printing, the position where the stopper of the carriage hits may be misaligned in the left and right, and the carriage may be tilted. In this case, fine adjustment such as providing a spacer in the striking portion of the stopper is provided in order to correct the tilt and the misalignment.

### BRIEF SUMMARY OF THE INVENTION

An adjusting mechanism includes, an adjusting plate that is provided in at least one end of an interlocking shaft that interlocks a pair of driving belts provided in a second direction and that is attached to an end of the interlocking shaft; and a screw type adjuster that is configured to be capable of adjusting a position of a moving body engaged to the pair of driving belts by being rotated to move the adjusting plate along a first direction different from the second direction.

### BRIEF DESCRIPTION OF THE SEVERAL VIEWS OF THE DRAWINGS

FIG. 1 is a perspective view viewing a main portion of a printing apparatus including the adjusting apparatus according to the present embodiment from the front and diagonally above.

FIG. 2 is a perspective view of the printing apparatus showing a state in which the carriage is moved to the front of the apparatus from the state shown in FIG. 1.

FIG. 3 is a plan view viewing the printing apparatus in a state shown in FIG. 2 from above.

FIG. 4A is a schematic plan view viewing an adjusting mechanism according to the present embodiment from above.

FIG. 4B is a perspective view of a main portion of a standing section.

FIG. 5 is a perspective view of the printing apparatus showing a state that the left side of the carriage is tilted downward to the rear of the apparatus than the right side.

FIG. 6 is a plan view viewing the printing apparatus from above in a state shown in FIG. 5.

FIG. 7A is a perspective view of a main portion viewing the adjusting mechanism according to the present embodiment from the side direction.

FIG. 7B is a perspective view of the main portion viewing the adjusting mechanism showing how the left side of the carriage is brought toward the front of the apparatus in order to correct the tilt.

FIG. 8 is a perspective view of the printing apparatus showing a state that the right side of the carriage is tilted downward to the rear of the apparatus than the left side.

FIG. 9 is a plan view viewing the printing apparatus in the state shown in FIG. 8 from the above direction.

FIG. 10A is a perspective view of the main portion viewing the adjusting mechanism according to the present embodiment from the side direction.

FIG. 10B is a perspective view of the main portion of the adjusting mechanism showing how the left side of the carriage is pulled to the rear of the apparatus in order to correct the tilt.

FIG. 11 is a perspective view of the printing apparatus including the adjusting mechanism as one modification of the present embodiment.

FIG. 12 is a plan view viewing the printing apparatus shown in FIG. 11 from the above direction.

### DETAILED DESCRIPTION OF THE INVENTION

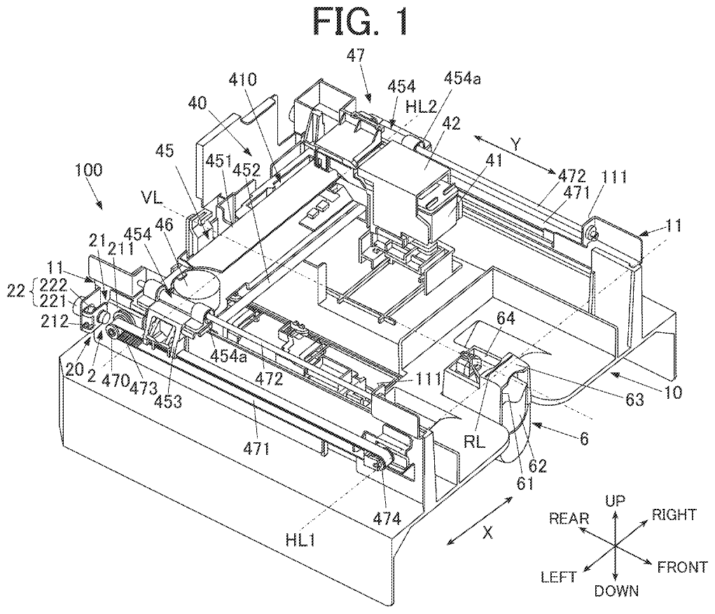

With reference to FIG. 1 to FIG. 10B, an embodiment of the adjusting mechanism and the printing apparatus according to the present invention is described.

Various limitations that are technically preferable for implementing the present invention are attached to the embodiments described below. However, the scope of the present invention is not limited to the embodiments and illustrated examples described below.

According to the present embodiment, a printing apparatus 100 is a nail print apparatus that performs printing on a nail of a hand of a person, for example. In the description below, the adjusting mechanism 2 is provided in the printing apparatus 100, but the apparatus in which the adjusting mechanism 2 is provided is not limited to the printing apparatus 100 such as the nail print apparatus.

According to the present embodiment, the printing apparatus 100 prints on a fingernail of the hand as a printing target. However, the printing target of the printing apparatus according to the present embodiment is not limited to the fingernail of the hand, and the fingernail of the foot may be the printing target. The printing target may be a target other than the nail such as a nail chip or a surface of various accessories.

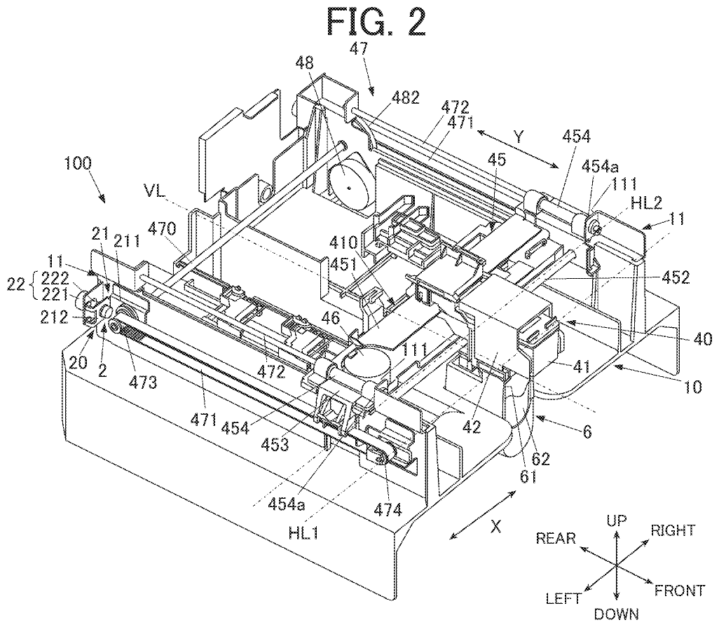

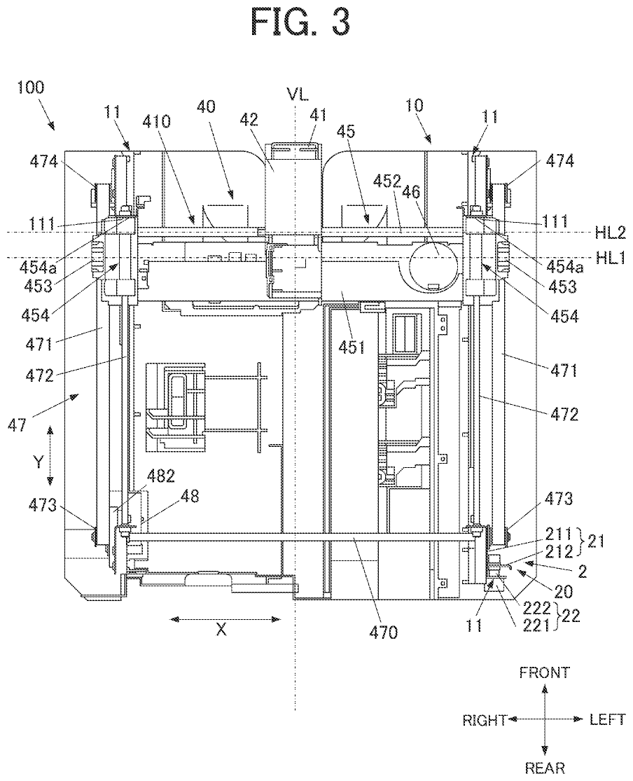

FIG. 1 and FIG. 2 are perspective views viewing the printing apparatus according to the present embodiment from above, and diagonally forward. FIG. 1 shows a state in which a carriage provided with the later-described print head is positioned to the rear of the apparatus. FIG. 2 shows a state in which the carriage is moved to the front of the apparatus. FIG. 3 is a plan view viewing the printing apparatus in a state shown in FIG. 2 from above.

According to the description below, up-down, left-right, and front-rear are directions shown in each diagram. The same can be said for an X-direction and Y-direction.

In FIG. 1 to FIG. 3, a line that is parallel to a center line in the X-direction of the printing apparatus 100 and that is along the Y-direction (front-rear direction of apparatus, this is to be “first direction”) is to be a vertical line VL, and a line that is orthogonal to the vertical line VL and that is along the X-direction (left-right direction of apparatus, this is to be “second direction”) is to be a horizontal line HL1. Each of the above is shown with a long and short dash line. Further, in FIG. 1 to FIG. 3, a line that is to be a reference for the direction of a moving body 410 is to be a line HL2 shown with a long and short dash line.

As shown in FIG. 1 to FIG. 3, the printing apparatus 100 includes a base 10, a finger holder 6 provided on the base 10, a base frame 11 assembled on the base 10, an adjusting mechanism 2 provided in the base frame 11, a printer 40 including the moving body 410 in which the tilt is adjusted by the adjusting mechanism 2, and the like.

Although illustration is omitted, the printing apparatus 100 includes a case (outer case) that stores the base 10 and the components of the apparatus positioned on the base 10 as shown in FIG. 1 to FIG. 3 so as to cover the above. The specific shape and configuration of the case are not limited.

The finger holder 6 holds the finger including the nail (both not illustrated) that is the printing target according to the present embodiment in a position suitable for printing.

The finger holder 6 is positioned in the base 10 in the substantial center in the left-right direction (X-direction) on the front surface side of the apparatus. The finger holder 6 includes an opening 61 on the front surface side of the apparatus. A finger fixer 62 is provided inside the finger holder 6. The finger fixer 62 pushes up and supports from the bottom side the finger inserted from the opening 61. The finger fixer is formed of a flexible resin, for example.

The upper surface of the finger holder 6 on the near side of the apparatus (front side in the Y-direction) is to be a finger presser 63 that prevents the finger from being lifted and regulates the position of the finger in the upward direction.

The upper surface of the finger holder 6 on the far side of the apparatus (rear side in Y-direction) is to be an open window 64. The nail of the finger inserted in the finger holder 6 is exposed from the window 64.

Since the finger is supported from the bottom by the finger fixer 62, and the upper side of the finger is held by the finger presser 63, the position in the height direction for the surface of the fingernail (printing target surface) exposed from the window 64 is determined to be a position suitable for performing printing by the later-described printer 40.

According to the present embodiment, a positioning line RL parallel to the horizontal line HL1 is provided on the surface (upper surface) of the finger presser 63. The positioning line RL is a line for confirming whether a direction of the moving body 410 (carriage 451 according to the present embodiment) which is the target in which the direction (tilt) is checked is parallel to the second direction (X-direction) that is orthogonal to the first direction (Y-direction) (that is, whether the horizontal line HL1 matches with the direction of the line HL2 that is to be the reference of the direction of the moving body 410).

The positioning line RL may be provided by printing, or may be a marked line.

It is not necessary to provide the positioning line RL. For example, the shape itself of the various components provided on the base 10 may include a line (surface) parallel to the horizontal line HL1, and such line (surface) can be matched with the direction of HL2 that is to be the reference of the moving body 410.

The base frame 11 is assembled on the base 10.

The base frame 11 is a frame shaped component formed by suitably bending sheet metal. The above is fixed on the base 10 by screws, etc. As described later, the printer 40 and the adjusting mechanism 2 are assembled on the base frame 11.

The printer 40 is a component in order to perform printing on the nail that is the printing target.

The printer 40 includes a moving body 410 that includes a printing operator that performs the printing operation and in which the tilt is adjusted by the later-described adjusting mechanism 2 so as to be in the direction orthogonal to the Y-direction (first direction).

The printer 40 according to the present embodiment includes a print head 41 as the printing operator, an X-direction movement mechanism 45 that moves the print head 41 in the left-right direction (X-direction, second direction) of the apparatus, a Y-direction movement mechanism 47 that moves the moving body 410 including the print head 41 in the front-rear direction (Y-direction, first direction) of the apparatus, and the like. The print head 41 is suitably moved in the X-direction and the Y-direction and the printing is performed.

In the print head 41 according to the present embodiment, the surface (lower side surface) facing the surface of the base 10 is to be an ink discharge surface (not shown) provided with a plurality of nozzle openings that discharge ink. The print head 41 is an inkjet head that produces fine droplets of ink and sprays the ink directly on the nail surface from the ink discharge surface to perform printing. According to the present embodiment, the print head 41 is configured to be capable of performing printing by a multi-pass method or singling printing, and fine printing can be performed on a surface of a nail or the like.

Although the configuration of the print head 41 is not limited, for example, the print head 41 may be a cartridge integrated head in which the discharging mechanism such as the ink discharge surface and the ink cartridge in which the ink is stored are formed as one.

For example, the print head 41 is able to discharge color ink in colors such as cyan (C; Cyan), magenta (M; Magenta), yellow (Y; Yellow), and the like. The type of print head 41 and the number of print heads 41 used is not limited. For example, in addition to the print head that discharges color ink as described above, the apparatus may include a base print head that prints a fluid that is to be a base before printing the design.

The X-direction movement mechanism 45 includes a carriage 451, an X-direction movement motor 46, etc., and the print head 41 is moved in the X-direction (direction orthogonal to the Y-direction which is the first direction, second direction).

Specifically, the print head 41 is attached to the carriage 451 of the X-direction movement mechanism 45 in a state supported by the holder 42.

The carriage 451 extends throughout the left-right direction (X-direction, second direction) of the apparatus.

A pulley that is not shown is provided inside the carriage 451 at both ends in the extending direction.

A drive belt (not shown) is wound around the pair of pulleys. One of the pulleys is connected to the X-direction movement motor 46 and by driving the X-direction movement motor 46, the pulley is rotated, and the driving belt wound around the pulley operates along the X-direction. In the carriage 451, a guide axis 452 is provided extending throughout the left-right direction (X-direction) of the apparatus parallel to the driving belt.

According to the present embodiment, as described above, a line parallel to the axis center of the guide axis 452 is to be the line HL2 that is the reference of the direction of the moving body 410 such as the carriage 451, etc.

The line HL2 is to be the reference of the direction of the moving body 410 and is not limited to the line parallel to the axis center of the guide axis 452. For example, the line that passes the center of a later described pair of left and right belt grips 453 in the Y-direction may be the line HL2 which is to be the reference of the direction of the moving body 410.

The print head 41 is engaged to the driving belt through the holder 42 in a state supported by the guide axis 452. With this, when the X-direction movement motor 46 is driven and the driving belt is operated, in response to the above, the print head 41 moves in the left-right direction (X-direction) of the apparatus along the horizontal line HL1 while being guided by the guide axis 452.

According to the present embodiment, the X-direction movement mechanism 45 includes the carriage 451, the driving belt wound around the pair of pulleys provided in the carriage 451, the X-direction movement motor 46, the guide axis 452 provided parallel to the driving belt, and the like.

The carriage 451 includes a belt clip 453 and an axis insertion portion 454 on each side (each end according to the present embodiment) of the extending direction (longitudinal direction of carriage 451, left-right direction, X-direction of apparatus according to the present embodiment).

The belt clip 453 is engaged to the pair of driving belts 471 (later-described) positioned parallel to the Y-direction which is the first direction. With this, both ends of the carriage 451 is fixed to the driving belt 471, and the carriage 451 is capable of moving along the Y-direction (first direction) according to the driving of the driving belt 471.

The axis insertion portion 454 includes a through hole (not shown) that penetrates the apparatus in the front-rear direction (Y-direction which is the first direction). A pair of guide axes 472 of a later-described Y-direction movement mechanism 47 is inserted through the through hole.

A surface of the axis insertion portion 454 on the close side of the apparatus is to be a striking portion 454a. When the carriage 451 moves to the front of the apparatus, the striking portion 454a provided on both ends of the carriage 451 strikes a striking surface 111 provided in the base frame 11 on the close side of the apparatus. According to the present embodiment, the striking position is to be a base point position that is the reference of the position of the moving body 410, and the striking surface 111 of the base frame 11 functions as a base definer that defines the base point position.

As described here, both ends of the carriage 451 are fixed to the pair of driving belts 471. The moving body 410 that moves in the Y-direction which is the first direction according to the present embodiment includes the print head and the carriage 451 provided with the print head 41.

In the normal state (that is, state in which the carriage 451 is not tilted), the carriage 451, the driving belt provided in the carriage 451, and the guide axis 452 are positioned so that the line HL2 parallel to the axis line of the guide axis 452 is parallel to the horizontal line HL1 and move along the Y-direction in this state (see FIG. 1 to FIG. 3).

The Y-direction movement mechanism 47 includes the base frame 11 provided on the left and the right of the base 10, pairs of pulleys 473 and 474, each pair provided to be in a front-rear direction (Y-direction) of the apparatus in each base frame 11, the driving belt 471 hung around the pulleys 473 and 474, an interlocking shaft 470 that interlocks with the pair of driving belts 471, a guide axis 472 provided parallel with the driving belt 471, a Y-direction driving motor 48, and the like.

Among the pulleys 473 and 474, either one is a driving pulley that is connected to the Y-direction driving motor 48 and rotates forward and reverse freely according to the driving of the motor. According to the present embodiment, the pulley 473 attached to the rear of the base frame 11 provided on the right side of the apparatus is the driving pulley connected to the Y-direction driving motor 48. The Y-direction driving motor 48 is suitably connected to the driving pulley (pulley 473) through a speed regulating gear 482 (see FIG. 2 and FIG. 3), and the rotating speed of the driving pulley (pulley 473) is adjusted.

The interlocking shaft 470 is a shaft extending throughout the left-right direction (X-direction) of the apparatus. The pulley 473 (driving pulley) provided on the right side of the apparatus is attached to the right side end of the interlocking shaft 470. The pulley 473 provided on the left side of the apparatus is attached to the left side end of the interlocking shaft 470.

When the pulley 473 which is the driving pulley rotates by driving the Y-direction driving motor 48, the other pulley 473 is interlocked with this movement through the interlocking shaft 470, and the left and the right operate at the same timing. With this, the left and right driving belts 471 provided in the base frames 11 on the left and the right of the apparatus are moved synchronized.

According to the present embodiment, the left and right pair of driving belts 471 are a toothed belt (cogged belt) and the operation can be controlled accurately. A tooth pitch of the driving belt 471 is to be 1 mm, etc., for example.

According to the present embodiment, the guide axis 472 extends in the moving direction of the print head 41 and the carriage 451 which are the moving body 410 (Y-direction that is the first direction according to the present embodiment) and guides the moving body 410. According to the present embodiment, the guide axes 472 are provided on the left and the right of the printing apparatus 100 to be parallel to the driving belt 471.

The carriage 451 included in the moving body 410 is fixed to the driving belt 471 by the belt clip 453 as described above. Therefore, according to the operation of the driving belt 471, the carriage is able to move in the front-rear direction (Y-direction) of the apparatus along the vertical line VL while being guided by the guide axis 472.

The printing apparatus 100 according to the present embodiment is a two-axis printing apparatus in which the print head 41 suitably moves in the X-direction and the Y-direction in order to perform the printing. The print head 41 moves in the axis in the X-direction and the axis in the Y-direction. Therefore, if the axis in the X-direction is not orthogonal to the axis in the Y-direction, exquisite printing cannot be performed.

The moving body 410 including the print head 41 is guided by the left and right pair of guide axes 472 and moves in the front-rear direction of the apparatus (Y-direction, first direction). However, if the moving body 410 is assembled in a state tilted with relation to the vertical line VL along the Y-direction (first direction), the moving body 410 moves in the Y-direction in a tilted state. Therefore, the axis in the X-direction (second direction) when the print head 41 moves is not orthogonal to the axis in the Y-direction (first direction) when the print head 41 moves.

Therefore, in order to maintain the operation accuracy of the printing apparatus 100 at a certain quality, for example, the moving body 410 needs to be assembled in a direction so that the line HL2 parallel to the axis line of the guide axis 452 is parallel to the horizontal line HL1 and it is necessary to adjust the line HL2 to be orthogonal with the vertical line VL.

According to the present embodiment, an adjusting mechanism 2 is provided in the printing apparatus 100 in order to adjust the direction of the moving body 410.

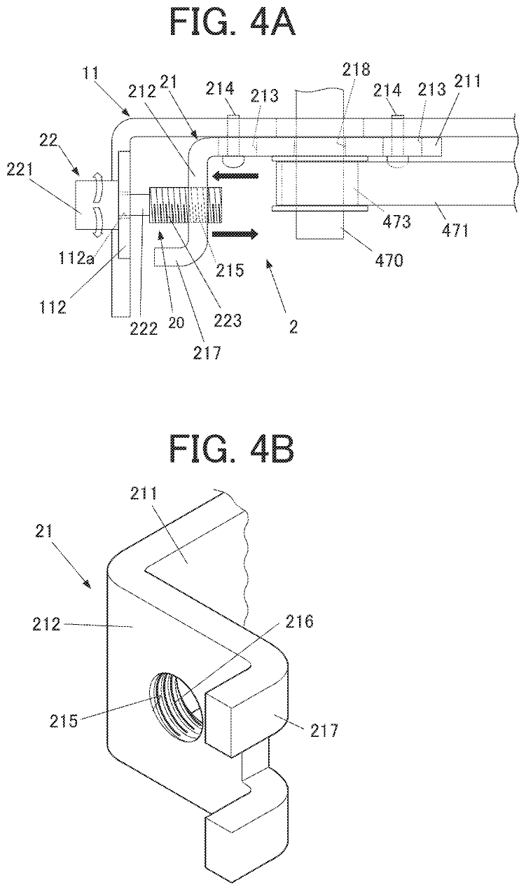

Here, with reference to FIG. 4A and FIG. 4B, the configuration of the adjusting mechanism 2 according to the present embodiment is described.

The adjusting mechanism 2 is provided in at least one end of the interlocking shaft 470 that interlocks with the pair of driving belts 471 positioned parallel to the Y-direction which is the first direction. The adjusting mechanism 2 adjusts the direction of the moving body 410 in which both ends are fixed to the pair of driving belts 471.

According to the present embodiment, the adjusting mechanism 2 is provided in only the left side end in the X-direction in the interlocking shaft 470 (see FIG. 1 to FIG. 3).

FIG. 4A is a plan view of the main portion of the adjusting mechanism 2 viewed from above. In FIG. 1 to FIG. 3, the illustration of the detailed configuration of the adjusting mechanism 2 is omitted.

As shown in FIG. 4A, etc., the adjusting mechanism 2 includes an adjusting plate 21 attached to the end of the interlocking shaft 470 and a screw type adjuster 20.

An axis engaging portion 112 in which a later-described operation screw 22 included in the screw type adjuster 20 is attached is provided on a side of the base frame 11 where the adjusting mechanism 2 is provided. The axis engaging portion 112 is provided to stand projecting out in the X-direction (second direction) orthogonal to the Y-direction from the base frame 11 extending in the Y-direction (first direction). For example, the axis engaging portion 112 is formed by processing the metal plate included in the base frame 11 to be bent.

The adjusting plate 21 is formed by processes such as bending the metal plate. The adjusting plate 21 includes an engaging plate 211 which is attached to the base frame 11 extending in the Y-direction (first direction) and a standing portion 212 provided standing to project in the X-direction (second direction) from the engaging plate 211.

A long hole 213 is formed in the Y-direction (first direction) in the engaging plate 211. By inserting an engaging screw 214 through the long hole 213, the engaging plate 211 is screwed to the base frame 11 through the long hole 213.

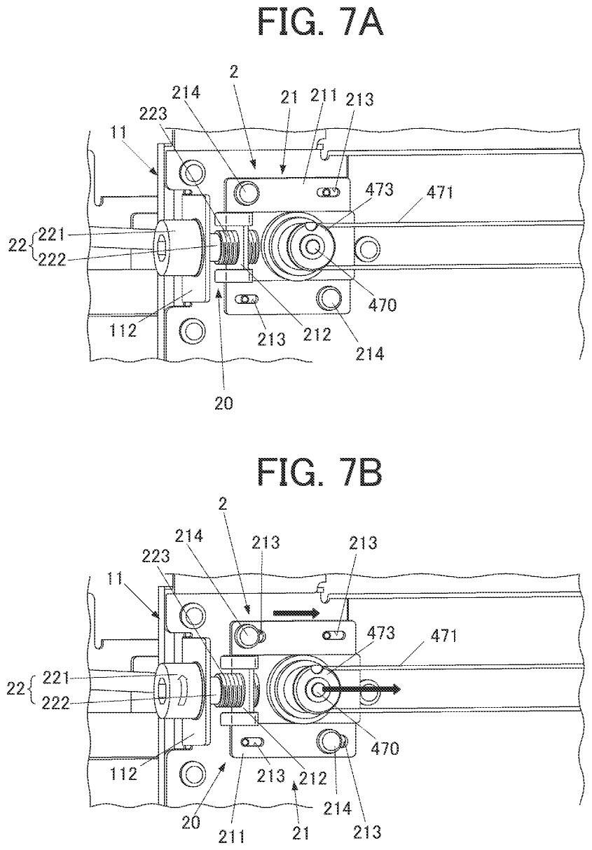

The number, position, shape and the like of the long hole 213 is not limited. According to the present embodiment, the long hole 213 is provided in two positions on the top and bottom of the engaging plate 211, the total being four long holes 213. Among the above, the engaging screw 214 is inserted through the long holes 213 in one position on the upper side in the rear of the apparatus and in one position on the lower side in the front of the apparatus (that is, two positions provided to be in alternate positions). With this, the engaging plate 211 (adjusting plate 21 including the engaging plate 211) is engaged to the base frame 11 (see FIG. 7A, FIG. 7B, etc.).

All of the long holes 213 may be screwed. However, when the adjusting by the adjusting mechanism 2 is performed, it is necessary to loosen the engaging screw 214 temporarily. Therefore, it is preferable to fix the components with a small number of screws. When four long holes 213 are provided in the two positions in the top and bottom as in the present embodiment, the long holes 213 in at least two positions which are in alternate positions are used to fix the screws. With this, the adjusting plate 21 is attached stably.

An insertion hole 218 through which the interlocking shaft 470 is inserted in a rotatable state is formed in the engaging plate 211. By inserting the interlocking shaft 470 through the insertion hole 218, the adjusting mechanism 2 provided with the adjusting plate 21 is attached to the interlocking shaft 470.

The adjusting plate 21 is able to move in the longitudinal direction of the long hole 213 (that is, the Y-direction which is the first direction) with the end of the interlocking shaft 470 by operating the screw type adjustor 20. That is, when adjustment is performed, the interlocking shaft 470 (and the pulley 473 attached to the end of the left side of the interlocking shaft 470) is moved together with the adjusting plate 21. Therefore, the portion corresponding to the interlocking shaft 470 in the base frame 11 is formed with a long hole or a cutout portion including a length equal to or longer than the long hole 213 (length in the Y-direction (first direction)) so as not to interfere even if the interlocking shaft 470 moves a little.

As shown in FIG. 4A, the standing portion 212 is provided to face the axis engaging portion 112 of the base frame 11.

FIG. 4B is a perspective view showing a main portion of the standing portion.

As shown in FIG. 4B, the tip side of the standing portion 212 is to be a striking portion 217 in which a bending process is performed to bend toward the axis engaging portion 112.

When the adjusting mechanism 2 performs the adjusting, the standing portion 212 becomes close and separated with relation to the axis engaging portion 112 by moving the screw type adjuster 20. If the distance becomes equal to or closer than a predetermined distance, a striking portion 217 strikes the axis engaging portion 112 and becomes a stopper. Therefore, it is possible to prevent the standing portion 212 from coming too close to the axis engaging portion 112 and colliding.

The screw type adjuster 20 includes an operation screw 22 including an operator 221 and an axis portion 222 extending from the operator 221, and an insertion hole 215 through which the axis portion 222 is inserted.

The side of the operator 221 in the operation screw 22 is attached to the base frame 11 (axis engaging portion 112 according to the present embodiment). That is, a through hole 112a is formed in the axis engaging portion 112, and the operation screw 22 is inserted in the through hole 112a from the rear of the apparatus. The through hole 112a has a diameter which is larger than the diameter of the axis portion 222 and a diameter that is smaller than the diameter of the operator 221. Therefore, when the operation screw 22 is inserted through the through hole 112a, the operator 221 strikes before the through hole 112a and cannot go through. Therefore, the operator screw 22 is engaged to the axis engaging portion 112, and does not fall off.

A male thread 223 is formed on the outer circumference of the axis 222.

The insertion hole 215 is provided in the adjusting plate 21. As shown in FIG. 4A and FIG. 4B, according to the present embodiment, the insertion hole 215 is formed in the standing portion 212.

As shown in FIG. 4B, on the inner circumference of the insertion hole 215, a female thread 216 that fastens with the male thread 223 formed on the operation screw 22 side is formed.

The screw type adjuster 20 is configured by being inserted through the insertion hole 215 in a state in which the operator 221 side is engaged with the axis engaging portion 112 on the base frame 11 side and the tip side of the axis portion 222 being in a state in which the male thread 223 is fastened with the female thread 216.

Then, the operation screw 22 is rotated clockwise or counter clockwise so as to be able to move the adjusting plate 21 attached to the axis portion 222 along the Y-direction (first direction).

When the operation screw 22 is rotated around the axis either clockwise or counter clockwise, the side (apparatus front or apparatus rear) to which the adjusting plate 21 moves (screwed forward or screwed reverse) along the Y-direction (first direction) depends on a threading direction of the male thread 223 and the female thread 216.

According to the present embodiment, when the operation screw 22 is rotated counter clockwise, the standing portion 212 is pressed to the front of the apparatus by the axis portion 222 of the operation screw 22 according to the amount of rotation. In this case, when the operation screw 22 is rotated in the opposite direction, that is, clockwise, the standing portion 212 is pulled to the rear of the apparatus by the axis portion 222 of the operation screw 22 according to the amount of rotation. With this, the standing portion 212, and thus the adjusting plate 21 and the end of the interlocking shaft 470 attached to the adjusting plate 21 moves to the front or the rear of the apparatus according to the Y-direction (first direction).

According to the present embodiment, as described above, the pair of driving belts 471 are toothed belts provided with teeth at a predetermined tooth pitch. The threading pitch of the male thread 223 of the operation screw 22 and the female thread 216 is set so that the amount of movement when the operation screw 22 is rotated once is smaller than the tooth pitch of the pair of driving belts 471.

Specifically, for example, if the tooth pitch of the driving belt 471 is 1 mm, the threading pitch of the male thread 223 of the operation screw 22 and the female thread 216 is set so that the amount of movement when the operation screw 22 is rotated once is 1 mm. In this case, if the operation screw 22 is rotated once, the adjustment of 1 mm the same as the tooth pitch is performed. If the operation screw 22 is rotated 1/4, the adjustment of 0.25 mm which is 1/4 of the tooth pitch can be performed, and if the operation screw 22 is rotated 1/2, the adjustment of 0.5 mm which is 1/2 of the tooth pitch can be performed.

According to the printing apparatus that performs the nail print, by performing the multi-pass printing, singling printing, and the like, exquisite designs can be printed on the nails. In such printing apparatuses that perform exquisite printing, for example, even misalignment of the printing position in about 1 mm causes misalignment of a print start position and a print end position. This results in decrease in quality of the printing result.

If the fine misalignment that is equal to or smaller than the tooth pitch of the driving belt 471 can be adjusted as in the present embodiment, high quality printing can be performed.

The rotating amount of the operation screw 22 corresponds to the moving amount of the adjusting plate 21. Therefore, for example, by showing in advance the rotating amount of the operation screw 22 corresponded with the moving amount of the adjusting plate 21 (tilt amount, tilt angle of moving body 410 that can be adjusted), it is possible to easily understand a guide of how much the operation screw 22 should be rotated in order to adjust a certain amount of the misalignment amount (tilt amount) of the moving body 410. Therefore, there is no need to repeat the adjustment many times or to perform test printing each time the adjustment is performed in order to confirm the result of the adjustment. With this, it is possible to save the burden in adjustment.

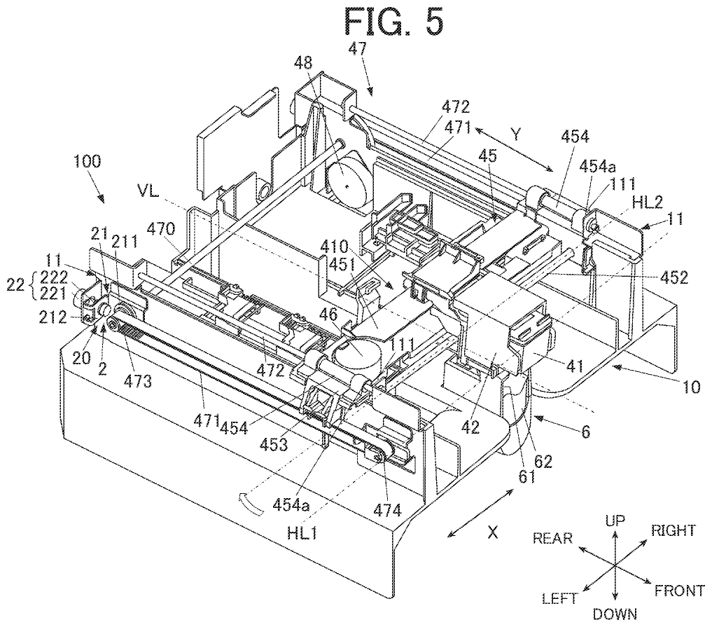

Next, with reference to FIG. 5 to FIG. 10A and FIG. 10B, the operation of the adjusting mechanism 2 and the printing apparatus 1 according to the present embodiment (that is, the adjusting method of the moving body 410 using the adjusting mechanism 2) is described.

The process described here is not the process assumed to be performed when the initialization is performed each time printing is performed. This process is assumed to be performed as an initial setting of the printing apparatus 100 at the time of shipment from the factory or the like. However, this does not exclude a typical user that uses the printing apparatus 100 from performing the adjusting process described below before the start of printing.

First, the moving body 410 included in the printer 40 is moved so that striking portions 454a which are front end surfaces of an axis insertion portion 454 provided on the left and the right of the carriage 451 are in positions that strike striking surfaces 111 of the base frame 11 which is a base point definer.

Then, it is confirmed whether the left and right striking portions 454a strike the striking surfaces 111. Such confirming can be performed by sight, or the confirming can be performed by a contact sensor.

As described above, in the printing apparatus 100, a positioning line RL parallel to the horizontal line HL1 is provided on the surface of the finger presser 63. By viewing the printing apparatus 100 from exactly above, the user confirms whether the axis of the moving body 410 in the extending direction (line HL2 in FIG. 5, etc.) matches with the positioning line RL.

Specifically, for example, the user confirms whether the axis line of the guide axis 434 provided in the carriage 451 matches with the positioning line RL. The object used for positioning with relation to the positioning line RL may be any object with which confirmation by viewing can be easily performed, and is not limited to the axis line of the guide axis 434.

For example, when the edge on the front end side of the carriage 451 is formed with a straight line that matches with the axis of the moving body 410 in the extending direction, the user may confirm whether the edge on the front end side of the carriage 451 matches with the positioning line RL.

As a result of confirming by sight, if the axis of the moving body 410 in the extending direction does not match with the positioning line RL (that is, misaligned with relation to the vertical line VL in the Y-direction, tilted), the adjustment by the adjusting mechanism 2 is performed.

If the misalignment (tilt) is equal to or larger than a tooth pitch of the driving belt 471 (for example, 1 mm), first the driving belt 471 which is the tooth belt may be adjusted in order to correct the misalignment (tilt).

If the misalignment (tilt) is fine and smaller than the tooth pitch of the driving belt 471 (for example, 1 mm), or the fine misalignment remains even after adjustment of the driving belt 471, further adjustment cannot be performed by the driving belt 471. In this case, fine adjustment of the direction of the moving body 410 is performed using the adjusting mechanism 2. Regardless of the amount of tilt, the direction of the moving body 410 can be adjusted using the adjusting mechanism 2.

Specifically, the adjustment by the adjusting mechanism 2 is performed by the following process, for example.

That is, first, the engaging screw 214 that fixes the adjusting plate 21 is loosened so that the adjusting plate 21 is in a movable state. Then, the operator 221 of the operation screw 22 is rotated clockwise or counter clockwise so that the adjusting plate 21 and the end of the interlocking shaft 470 attached to the adjusting plate 21 are moved along the Y-direction (first direction).

After confirming that the direction of the moving body 410 is in the correct direction, that is, the axis line of the moving body 410 in the extending direction (line HL2 in FIG. 5, etc.) is in the direction parallel to the line (horizontal line HL1) in the X-direction that is the second direction orthogonal to the Y-direction that is the first direction (whether the line HL2 is parallel to the positioning line RL), and the direction of the moving body 410 is in the correct direction, the engaging screw 214 is tightened again in this position, and the adjusting plate 21 is fixed.

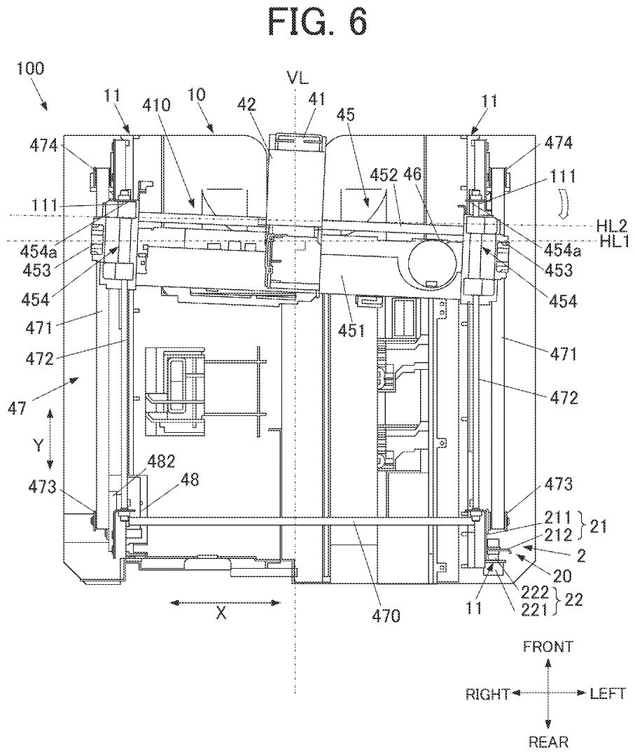

For example, FIG. 5 and FIG. 6 describe an example in which the position of the moving body 410 such as the carriage 451 is slightly lowered to the rear of the apparatus in the left side than the right side (shown with a white arrow in FIG. 5 and FIG. 6).

In this case, as shown in FIG. 5 and FIG. 6, the striking portion 454a which is the front end surface of the axis insertion portion 454 provided on the right side of the carriage 451 strikes the striking surface 111 of the base frame 11 which is the base point definer. However, the striking portion 454a which is the front end surface of the axis insertion portion 454 provided on the left side of the carriage 451 does not strike the striking surface 111 of the base frame 11, and there is a gap.

In this case, it is necessary to bring the left side of the moving body 410 toward the front of the apparatus to the position the same as the right side.

FIG. 7A is a perspective view of a main portion showing a configuration of an adjusting mechanism before the adjusting operation, and FIG. 7B is a perspective view of a main portion showing adjustment by the adjusting mechanism.

If the adjusting mechanism 2 is provided on the left side of the apparatus in the X-direction as in the present embodiment, and the left side of the moving body 410 is lowered to the rear than the right side, the adjusting mechanism 2 is operated to push the adjusting plate 21 and the left side end of the interlocking shaft 470 attached to the adjusting plate 21 toward the front of the apparatus in order to adjust the direction of the moving apparatus.

That is, as shown in FIG. 7B, the operator 221 of the operation screw 22 is rotated in the direction shown with a white arrow shown around the operator 221 in FIG. 7B (counter clockwise direction). With this, the axis 22 in which the male thread 223 is provided rotates counter clockwise around the axis, and the standing portion 212 including the female thread 216 fastened with the male thread 223 moves in an amount of the rotation of the axis 22 toward the front of the apparatus (direction shown with a black arrow). By moving (pushing) the standing portion 212, the left side end of the interlocking shaft 470 attached to the adjusting plate 21 also similarly moves toward the front of the apparatus shown with the black arrow.

When the left side end of the interlocking shaft 470 moves, the pulley 473 in which the driving belt 471 on the left side of the apparatus is wound moves in a direction closer to the pulley 474 at the front of the apparatus.

Here, the pulley 474 at the front of the apparatus is provided with a tension applying means such as a coil spring which is not shown. Therefore, even if the pulley 473 comes close to the pulley 474 at the front of the apparatus, certain tension is applied to the driving belt 471, and bending is not formed in the driving belt 471.

The method to apply tension to the driving belt 471 is not limited to the coil spring, and certain tension can be applied by pressing the tension applying means against the driving belt 471 from the side direction.

As described above, when the tension applying means that applies certain tension on the driving belt 471 is provided, the backlash that occurs when the operation screw 22 is rotated and the adjustment by the adjusting plate 21 is performed can be suppressed.

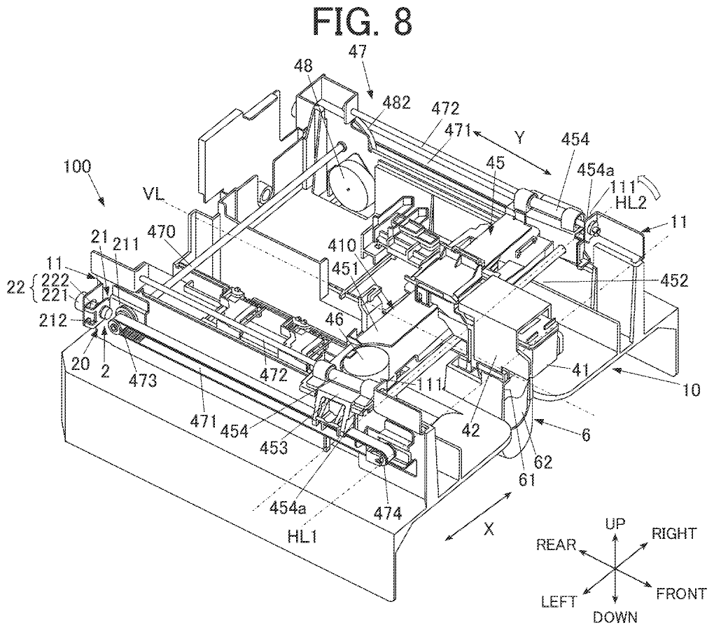

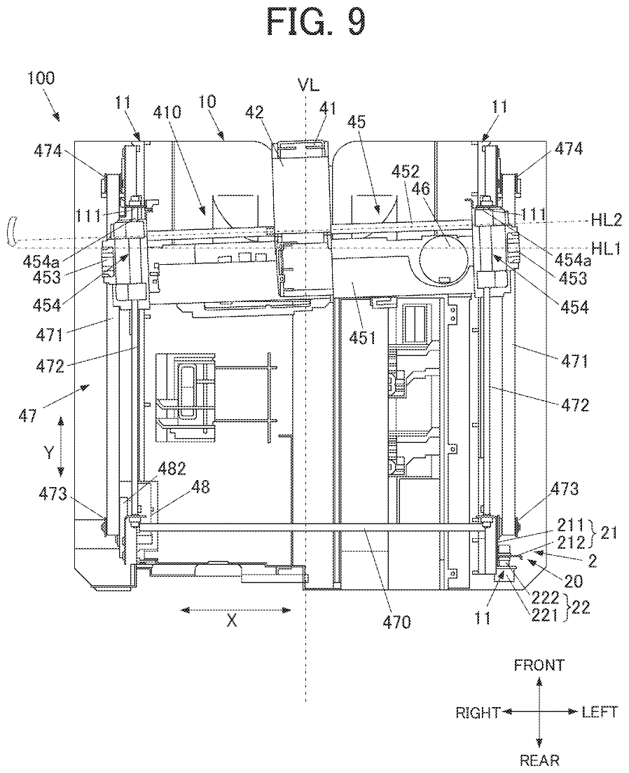

FIG. 8 and FIG. 9 illustrate the moving body 410 such as the carriage 451, etc. lowered slightly to the rear of the apparatus on the right side than the left side (shown with white arrows in FIG. 8 and FIG. 9).

In this case, as shown in FIG. 8 and FIG. 9, the striking portion 454a which is the front end surface of the axis insertion portion 454 provided on the left side of the cartridge 451 strikes the striking surface 111 of the base frame 11 which is the base definer. However, the striking portion 454a which is the front end surface of the axis insertion portion 454 provided on the right side of the carriage 451 does not strike the striking surface 111 of the frame base 11, and there is a gap.

In this case, it is necessary to align the right side of the moving body 410 to the same position as the left side.

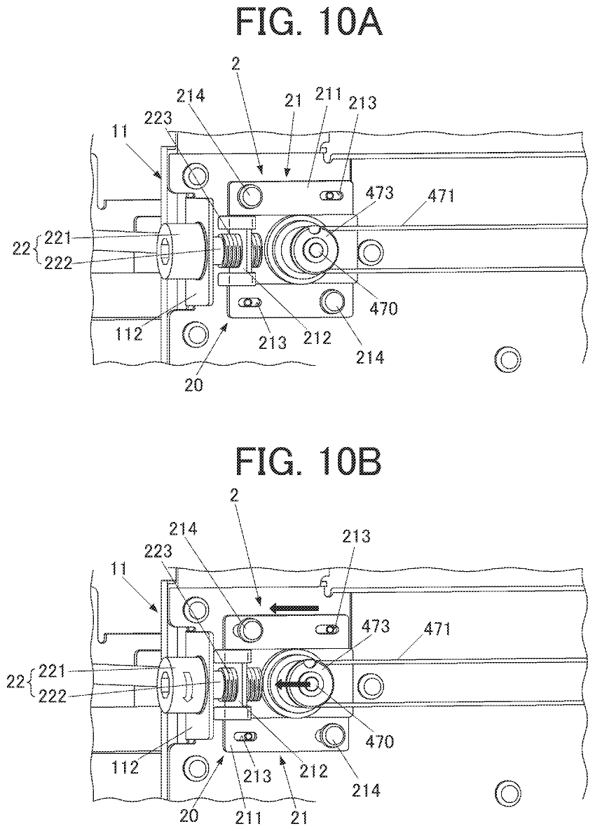

FIG. 10A is a perspective view showing the configuration of the main portion of the adjusting mechanism before the adjusting operation, and FIG. 10B is a perspective view of the main portion showing the adjustment by the adjusting mechanism.

If the adjusting mechanism 2 is provided on the left side of the apparatus in the X-direction as in the present embodiment, and the right side of the moving body 410 is lowered to the rear than the left side, the adjusting mechanism 2 is operated to pull the adjusting plate 21 and the left side end of the interlocking shaft 470 attached to the adjusting plate 21 to the rear of the apparatus in order to adjust the direction of the moving body 410.

That is, as shown in FIG. 10B, the operator 221 of the operation screw 22 is rotated in the direction (clockwise direction) shown with a white arrow around the operator 221 in FIG. 10B. With this, the axis 22 provided with the male thread 223 is rotated clockwise around the axis, and the standing portion 212 including the female thread 216 that fastens with the male thread 223 is moved to the rear of the apparatus (direction shown with a black arrow) in the amount that the axis 22 is rotated. By moving the standing portion 212 (pulled in a direction closer to the axis engaging portion 112), the left side end of the interlocking shaft 470 attached to the adjusting plate 21 is also similarly moved toward the rear of the apparatus shown with the black arrow.

Since the left side end of the interlocking shaft 470 moves, the pulley 473 in which the driving belt 471 on the left side of the apparatus is wound moves in the direction away from the pulley 474 in the front of the apparatus.

In this case also, the tension applied to the driving belt 471 can be maintained to a certain degree by providing a tension applying means such as coil springs.

According to the present embodiment, as described above, the threading pitch of the male thread 223 and the female thread 216 is set so that the amount of movement when the operation screw is rotated once is smaller than the tooth pitch of the pair of driving belts 471. Therefore, when the adjusting plate 21 is moved to either the front direction or the rear direction of the apparatus, it is possible to adjust the fine misalignment (tilt) with higher accuracy than when the adjustment is performed using the tooth pitch of the driving belt 471.

In the printing apparatus 100 after performing adjustment using the adjusting mechanism 2, the line HL2 parallel to the axis center of the guide axis 452 of the moving body 410 is parallel to the horizontal line HL1 and orthogonal with relation to the vertical line VL.

With this, the moving body 410 including the print head 41 is able to operate correctly in the X-direction and the Y-direction, and high precision printing can be performed.

As described above, the adjusting apparatus 2 according to the present embodiment is provided in at least either one end (end on the left side of the apparatus according to the present embodiment) of the interlocking shaft 470 interlocked with the pair of driving belts 471 positioned parallel with the Y-direction in the first direction. The adjusting apparatus 2 includes an adjusting plate 21 attached to the end of the interlocking shaft 470 and the screw type adjuster 20 that can move the adjusting plate 21 along the Y-direction (first direction). With this, the direction of the moving body 410 in which each end is fixed to the pair of driving belts 471 is adjusted.

Therefore, the moving body 410 can be adjusted in the correct direction with a relatively easy configuration such as the adjusting plate 21 and the screw type adjuster 20.

Therefore, the moving body 410 of the printing apparatus 100 can realize high quality printing in which the printing start position and the printing end position are aligned in the correct position.

The adjusting plate 21 according to the present embodiment is screwed to the base frame 11 through the long hole 213 long in the Y-direction (first direction). By operating the screw adjuster 20, the adjusting plate 21 can move in the longitudinal direction (that is, Y-direction which is the first direction) of the long hole 213 together with the end of the interlocking shaft 470.

As described above, it is possible to realize a configuration that allows the adjusting plate 21 to move in the first direction (Y-direction) with a simple configuration.

Therefore, the direction of the moving body 410 can be adjusted easily while suppressing the increase of the number of components.

The screw type adjuster 20 according to the present embodiment includes the operation screw 22 that includes an operator 221, and an axis 222 that extends from the operator 221, in which the operator 221 side is fixed to the base frame 11, and in which the male thread 223 is formed around the axis 222, and the insertion hole 215 that is formed in the adjusting plate 21 and in which a female thread 216 that fastens with the male thread 223 is formed on the inner circumference. The tip side of the axis 222 is inserted in the insertion hole 215 in a state in which the male thread 223 is fastened with the female thread 216.

With this, it is possible to adjust the direction of the moving body 410 accurately with a relatively easy configuration.

Moreover, the rotating amount of the operation screw 22 corresponds to the moving amount of the adjusting plate 21. Therefore, for example, the rotating amount of the operation screw 22 is shown corresponded with the moving amount of the adjusting plate 21 in advance (tilt amount of the moving body 410 that can be adjusted, tilt angle). Therefore, it is possible to easily understand the guide of how much the operation screw 22 is to be rotated in order to be able to adjust a certain degree of the misalignment amount (tilt amount) of the moving body 410.

Therefore, it is possible to save the burden of repeating the adjustment many times or confirming the adjustment result by test printing each time the adjustment is performed. With this, the adjustment of the direction of the moving body 410 can be performed efficiently.

According to the present embodiment, the pair of driving belts 471 is a toothed belt, and the threading pitch of the male thread 223 in the operation screw 22 and the female thread 216 is set so that the moving amount of one rotation of the operation screw 22 is smaller than the tooth pitch of the pair of driving belts 471.

For the purpose of stable operation, the tooth belt needs to include a tooth pitch with a certain degree (for example, about 1 mm). If the misalignment which is equal to or larger than the tooth pitch is adjusted, the adjustment can be made by adjusting the driving belt 471.

However, according to the printing apparatus that performs the nail print, multi-pass printing and singling printing are performed, and it is required to exquisitely print fine designs on the nails. In such printing apparatuses that perform exquisite printing, for example, a misalignment in the printing position of about 1 mm causes misalignment in the print start position and the print end position. This influences the printing result.

As in the present embodiment, if the threading pitch is set so that the moving amount when the operation screw 22 is rotated once is smaller than the tooth pitch of the driving belt 471, it is possible to adjust fine misalignment that is equal to or smaller than the tooth pitch of the driving belt 471. Therefore, the moving body 410 of the printing apparatus 100 can be adjusted to be able to perform high quality printing.

Consequently, high definition nail printing can be performed.

The printing apparatus 100 according to the present embodiment includes the adjusting mechanism 2 as described above, and a moving body 410 that includes a print head 41 as the printing operator that performs the printing operation, in which each end is fixed to the pair of driving belts 471 positioned parallel to the Y-direction which is the first direction, and in which the direction is adjusted in the direction orthogonal to the Y-direction (first direction) by the adjusting mechanism 2.

With this, it is possible to realize a printing apparatus 100 that performs high definition printing without misalignment in the printing position.

Therefore, it is possible to achieve high quality printing results even if fine designs such as nail designs are printed.

According to the present embodiment, the apparatus includes the base frame 11 in which the adjusting mechanism 2 is assembled, and the base frame 11 includes the striking surface 111 as the base point definer that defines the base point position that is to be the reference of the position of the moving body 410.

With this, the moving body 410 can be easily matched to the base point position of the moving body 410 (origin position in the Y-direction), and high quality printing can be performed.

According to the present embodiment, a positioning line RL is provided in order to confirm whether the direction of the moving body 410 is parallel to the X-direction which is the second direction orthogonal to the Y-direction which is the first direction.

Therefore, the direction of the moving body 410 can be easily confirmed by sight.

Although various embodiments of the present invention have been described above, the present invention is not limited to the above embodiments, and various modifications are possible without leaving the scope of the present invention.

For example, according to the present embodiment, the moving body 410 including the printing operator that performs the printing operation includes the print head 41 as the printing operator and the carriage 451, but the configuration of the moving body 410 is not limited to the above.

For example, the print head 41 may extend in the X-direction orthogonal to the moving direction in the Y-direction, the carriage may not be provided, and the print head 41 may move in the Y-direction as the moving body 410.

In this case, the straight line portion that is to be originally parallel with the horizontal line HL1 such as the front end surface, etc. of the print head 41 is to be the line HL2, and this is matched with the positioning line RL. With this, it is possible to confirm whether the moving body 410 is misaligned with relation to the moving direction.

According to the present embodiment, the adjusting mechanism 2 is provided only in the left side end of the interlocking shaft 470 in the X-direction, but the position where the adjusting mechanism 2 is provided is not limited to the above.

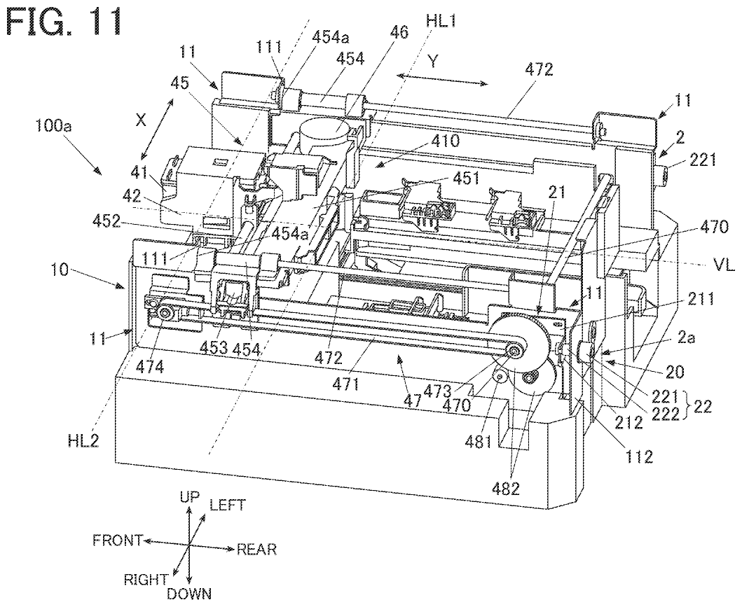

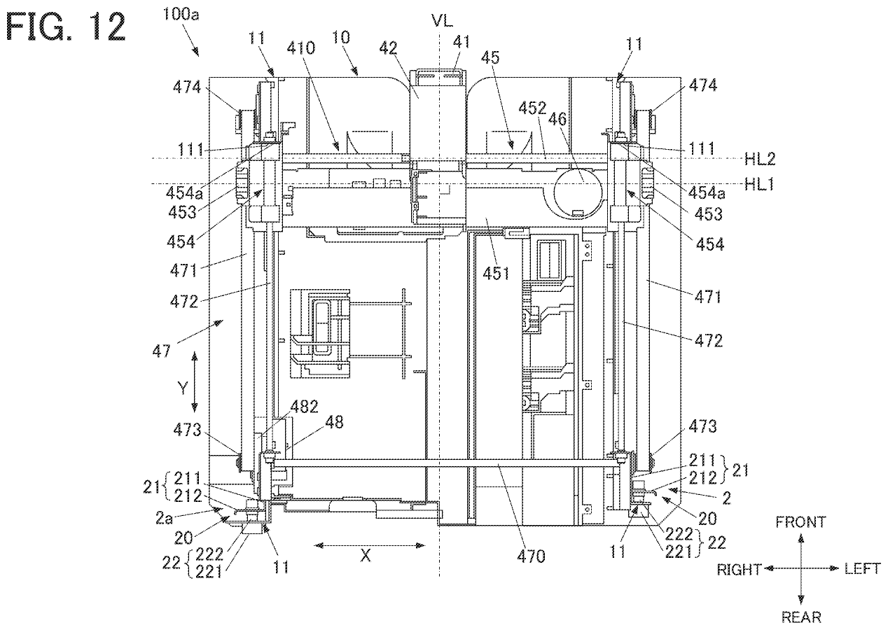

For example, as shown in FIG. 11 and FIG. 12, the adjusting mechanism 2 can be provided in ends on both sides of the interlocking shaft 470 of a printing apparatus 100a.

FIG. 11 and FIG. 12 show the adjusting mechanism 2 provided in the left side end of the interlocking shaft 470 in the X-direction. This is similar to the embodiment described above and the description is omitted.

In FIG. 11 and FIG. 12, the adjusting mechanism 2a provided in the right side end of the interlocking shaft 470 in the X-direction is similar to the adjusting mechanism 2 provided on the left side end of the interlocking shaft 470, and includes the adjusting plate 21 and the screw type adjuster 20.

The pulley 473 attached to the right side end of the interlocking shaft 470 provided on the right side of the apparatus is a driving pulley that is connected to the Y-direction driving motor 48 and that rotates forward and reverse freely according to the driving of the motor. Therefore, other than the Y-direction driving motor 48, one or a plurality of speed regulating gears 482 are linked to the pulley 473. Therefore, in the adjusting plate 21 of the adjusting mechanism 2a provided on the right side end of the interlocking shaft 470, in addition to the right side end of the interlocking shaft 470 being attached, the pulley 473 and the Y-direction driving motor 48 and the speed regulating gear 482 connected to the pulley 473 are assembled. When the end of the interlocking shaft 470 moves in the Y-direction together with the adjusting plate 21, the Y-direction driving motor 48 and the speed regulating gear 482 also move.

The configuration of the other portions are the same as the adjusting mechanism 2 provided in the left side end of the interlocking shaft 470 and the description is omitted.

When the adjusting mechanism 2 is provided in both ends of the interlocking shaft 470, compared to moving only one side of the moving body 410 (left side in X-direction according to the present embodiment) to the front or rear of the apparatus along the Y-direction, the tilt of the moving body 410 can be adjusted from both the left and right side using the center of the moving body 410 in the X-direction and the Y-direction as the reference (center in the X-direction and Y-direction in the print head 41 and the carriage 451 including the print head 41).

Therefore, fine adjustment can be performed at the actual center of the print head 41 and the carriage 451 in the X-direction and the Y-direction placing in the center the print head 41 which is placed in the center of the print position.

With this, the adjustment can be performed with reference to the actual printing area and further improvement of the printing accuracy is expected.

According to the present embodiment, the positioning line RL is provided on the surface (upper surface) of the finger presser 63 of the finger holder 6. However, the position where the positioning line RL is provided is not limited to the above. The positioning line RL can be provided in a position which can be referred when the direction (tilt) of the moving body 410 is confirmed as described later, and may be provided on the upper surface of the base 10, for example.

The positioning line RL is to be provided in the position in which a height difference from the moving body 410 (carriage 451 according to the present embodiment) which is the target of confirming the tilt is as small as possible. This is because the accuracy when confirming by sight increases, and it is possible to confirm the positioning more easily and securely.

Therefore, for example, a stage in a position at a height that does not interfere with the lower edge of the moving body 410 is provided in the far side of the finger holder 6 or the side of the finger holder 6 at a height the same as the finger presser 63 of the finger holder 6, and the positioning line RL may be provided on the upper surface of this stage.

A mark or a scale such as the positioning line RL can be provided in a portion of the base frame 11 and the positioning can be performed by sight.

According to the present embodiment, each of the pair of driving belts 471 that move the moving body 410 is positioned on the left and the right of the apparatus in the width direction (X-direction) and the moving body 410 moves along the apparatus in the front-rear direction (Y-direction) but the moving direction of the moving body 410 is not limited to the above.

For example, the configuration of the present invention can be applied when each of the pair of driving belts 471 that move the moving body 410 are positioned in the front and the rear in a depth direction (Y-direction) of the apparatus and the moving body 410 moves along the left-right direction (X-direction) of the apparatus.

Although various embodiments of the present invention are described, the scope of the present invention is not limited to the above-described embodiments, and the scope of the present invention includes the scope as described in the attached claims and its equivalents.

What is claimed is:

1. An adjusting mechanism comprising:
an adjusting plate that is provided in at least one end of an interlocking shaft that interlocks a pair of driving belts provided in a second direction and that is attached to an end of the interlocking shaft; and
a screw type adjuster that is configured to be capable of adjusting a position of a moving body engaged to the pair of driving belts by being rotated to move the adjusting plate along a first direction different from the second direction.

2. The adjusting mechanism according to claim 1, wherein,
the adjusting plate is screwed to a base frame through a long hole that is long in the first direction, and
the adjusting plate is configured to be capable of moving in a longitudinal direction of the long hole with the end of the interlocking shaft by operating the screw type adjuster.

3. The adjusting mechanism according to claim 2, wherein, the screw type adjuster includes,
an operation screw that includes an operator and an axis that extends from the operator, in which the operation side is fixed to the base frame, and in which a male thread is formed around the axis, and
an insertion hole that is formed in the adjusting plate and in which a female thread that fastens with the male thread is formed on an inner circumference, and
in a state in which the male thread is fastened with the female thread, a tip side of the axis is inserted in the insertion hole.

4. The adjusting mechanism according to claim 3, wherein,
the pair of driving belts is a toothed belt,
a threading pitch of the male thread in the operation screw and the female thread is set so that a moving amount when the operation screw is rotated once is smaller than a tooth pitch of the pair of driving belts.

5. The adjusting mechanism according to claim 1, wherein, the adjusting plate and the screw type adjuster are provided in both ends of the interlocking shaft.

6. A printing apparatus comprising:
the adjusting mechanism as described in claim 1; and
a moving body that includes a printing operator that performs a printing operation and in which both ends are fixed to the pair of driving belts provided in the second direction and that is adjusted in the second direction by the adjusting mechanism.

7. The printing apparatus according to claim 6, further comprising a base frame in which the adjusting mechanism is assembled,
wherein, the base frame includes a base point definer that defines a base point position that is to be a reference of a position of the moving body.

8. The printing apparatus according to claim 6, wherein, a positioning line with which whether the direction of the moving body is parallel with the second direction is confirmed is provided.
